(19) United States
(12) Patent Application Publication
(10) Pub. No.: US 2010/0284668 A1
(43) Pub. Date: Nov. 11, 2010

(54) MOBILE VIRTUAL PERSONAL VIDEO RECORDER

(75) Inventor: Phil Knight, Surrey (GB)

Correspondence Address: KF ROSS PC, 5683 RIVERDALE AVENUE, SUITE 203 BOX 900, BRONX, NY, 10471-0900, US

(73) Assignee: DEUTSCHE TELEKOM AG, Bonn (DE)

(21) Appl. No.: 12/738,852

(22) PCT Filed: Sep. 15, 2008
(86) PCT No.: PCT/EP2008/007635

§ 371 Date: May 28, 2010

(30) Foreign Application Priority Data
Dec. 14, 2007 (EP) 07024328.2

(51) Int. Cl. H04N 9/80

(52) U.S. Cl. 386/248; 386/E05.001

(57) ABSTRACT

Method for storage and/or access of records of television programs, which are recorded by a personal video recorder (1), characterized in that the personal video recorder (1) is at least temporarily connectable to a server (3) using a communication channel (2) and that via said channel (2) the identity and other parameters of the recorded program are transferred to the server (3) and stored as a dataset into a database (4). This program identity information can them be used subsequently to allow access from a video on demand server to create a virtual PVR without the need for transfer of the actual streamed data in total.

The invention relates to a Method for storage and/or access of records of television programs, which are recorded by a personal video recorder (PVR).

Such personal video recorders (PVR) are used for recording television programs for viewing later and/or for storing the content.

Typically on a PVR system there will be some form of electronic program guide available, or some method for the customer to discover, review and decide to record a suite of programs that they are interested in viewing multiple times or at some future time.

Typically this set of choices is programmed into the PVR and the PVR will autonomously then record the program. Alternatively the PVR can typically be set to record a program that is occurring at the instant that the customer is present, such that for instance the customer can then view an alternative channel and come back to also review the recorded content at a later time. The known recording systems may be very complicated to use and to be programmed to record a selected program, in particular when used via a small screen device such as a mobile phone.

Further there is known web-based video on demand systems. A great disadvantage of said video on demand systems (VOD) is that the user only can choose out of a limited list of content may be without covering his special interests.

The object of the invention is to provide a video on demand system including the possibility to govern the content of such video on demand system and to perform an easier way to control a video recording system.

This object is achieved according to the invention by a method with the characteristics mentioned in claim 1. Preferred embodiments of the invention result from the characteristics mentioned in the dependent claims.

It is an advantage of the invention, that the method for storage and/or access of records of television programs, which are recorded by a personal video recorder, is characterized in that the personal video recorder is at least temporarily connectable to a server using a communication channel and that via said channel the identity (title and other relevant information) of the recorded program is transferred to the server and stored as a dataset into a database.

The basis of this application is to implement a virtual PVR (personal video reorder) in a network like the ‘internet’ such that it is synchronized with an actual PVR in a consumers residence. The benefit of this is then that the CPE (customer premises equipment) installation and equipment can be simplified and the clash of a user watching the PVR in the main residence and someone else wanting to watch recorded content elsewhere will not happen. The CPE (customer premises equipment) may be a mobile equipment, e.g. a mobile phone or a laptop, or suitable integrated radio modem in the PVR itself, using e.g. a public land mobile network (PLMN) for communication.

This concept is intended to be relevant for mobile access in particular to the recorded content, e.g. via a mobile phone with suitable streaming capability, or via a laptop

accessing the internet from a connection which may or may not be at the main residence where the PVR is situated.

Preferably the server is a network based server, particularly a web server. Using a web server it is possible to use network resources in a very simple and advantageously way.

Preferably the transferred and stored dataset includes further recording information, particularly the program title and/or the date of recording and/or the length of recording and/or whether the program is a part of a series and/or program classification. That means, that the central server can be informed of a wider range of information concerning the recorded programs and content, this would include but is not limited to:
The program title and date of recording
Whether the program is part of a series that the customer has indicated they want recording
Any rating that the customer has assigned to the program in terms of a favorites marking, or any other form of assessment

The classification of the program can be a sorted list of favorites or any other form of assessment given by the user or alternatively automatically generated, e.g. by detecting the quantity of records of a special class of program or of special series.

Preferably the communication channel is using a telephone modem and/or dial up internet access and/or broadband internet access and/or a wireless system, particularly wireless ethernet and/or bluetooth to a transceiver and/or a mobile telephone connection via a public land mobile network. The communication between the video recorder (PVR) and the server/database can be very low bandwidth, due to the fact, that only the identity of the recorded programs is transferred, (title and other relevant information).

Preferably the video recorder is at least connected to the server on every recording or deleting event an the personal video recorder and/or periodic, particularly after a settable period.

Preferably the database is updated by storing and/or deleting datasets or streams on every recording or deleting event an the personal video recorder and/or periodic, particularly after a settable period.

The trigger for the communication between the PVR and the central server could be but is not limited to the following:
A recording/deleting event at the PVR
A periodic update
A response to a request for information received from the central network server via a suitable channel (e.g. a downlink satellite broadcast channel)

Preferably the personal video recorder is identified by an identification and/or authentification. Using an identification and/or authentification of the video recording system which is allowed to connect to the server and the database for writing or deleting datasets it is possible to reduce the risk of an error or intrusion of an illegitimate person.

Preferably the server and/or the database are accessed by mobile equipment using a communication channel, particularly by a mobile phone or a laptop computer. The database including the stored content, i.e. the identity of the recorded television programs, are downloaded by using mobile equipment and displayed on the display of the mobile equipment, whereas the display can be integrated or connected to the mobile equipment, in particular a mobile phone or a laptop. For starting the connection and downloads the database is accessed by the mobile equipment using a mobile communication channel, e.g. via a public land mobile network and via the server. Preferably the communication channel used by the mobile equipment is a public land mobile network.

Preferably the mobile equipment is identified by a identification and/or authentification. Using a identification and/or authentification of the mobile equipment it is possible to reduce the risk of an error or intrusion of an illegitimate person. Consideration must also be given to the authentication and identification of the PVR so that the probability of an intruder deliberately or erroneously accessing the data store of another valid PVR is close to zero.

Preferably one or more personal video recorder/s and one or more mobile equipment/s, which are accessible to the server and/or the database, are paired by the server by identification and/or authentification of the personal video recorder/s and the mobile equipment/s.

The PVR and mobile terminal must be paired though the subscription in the network server. This means that part of the initial provisioning process must allow for the network server to discover the identity of the mobile terminal, the identity of the PVR, and to pair them, this discovery must be secure and reliable. One or more PVRs could be paired to one or more mobile terminals allowing the sharing of content between a family or other grouping. It is possible to identify mobile equipment is by using the Mobile Subscriber Integrated Services Digital Network Number (MSISDN).

Preferably the one or more personal video recorder/s and/or one or more mobile equipment/s are identified by capturing username and password.

Preferably a list of recorded datasets is available from the database by mobile equipment particularly that said list is displayed by the mobile equipment. Having accessed the list of stored content, a page of some form is rendered at the mobile terminal to represent an electronic program guide of the stored content. This may be for instance a web page in the case that the mobile device is accessing via a browser, or a proprietary coding or some other standard coding if the mobile device is accessing by a non browser application, for instance a client designed specifically for this purpose.

Preferably a selectable dataset is transferable as a datastream from the database via the server and the communication channel to mobile equipment.

Preferably an electronic program guide is transferred to mobile equipment and displayed by the mobile equipment or displayed by a display connected to the mobile equipment. The display may be integrated e.g. into a mobile phone or may be an external device with a (bigger) screen.

Preferably programs to be recorded by the personal video recorder can be selected from an electronic program guide using mobile equipment by transmitting a recording instruction from the mobile equipment via the server to the personal video recorder.

Preferably a list of similar or supplemental programs is provided by the server. This then opens the opportunity to allow the operator of the service to use a recommendation engine to push other viewing suggestion which can be any content from the entire catalogue, based on for instance but not limited to:
The customers known viewing history
The current total content of their PVR
The currently selection that the customer has made on the mobile terminal
Recommendations from other customers with similar viewing patterns.

The benefits and possibilities of the invention are several folds:
Only a limited uplink channel is needed from the PVR in situ to the network in order to provide a full service to the ‘mobile customer’
The ‘mobile customer’ can watch pre-recorded content independently of the customer using the physical PVR, clashes are therefore avoided. This may be of great benefit even in the home where otherwise a clash would have occurred stimulating discord between the individuals involved.
There is no need for the PVR to be connected to a broadband internet access point or to use substantial data allowances as would be the case if the content were streamed directly from the physical PVR.
The installation of the CPE equipment is simpler than the use of an external system to stream content from the PVR via a broadband comm link as is a frequently used system.
The terminal can act as a mechanism to control what new content is being recorded onto the PVR1 because it has access to the EPG. It is noted that such systems already exist.
The fact that the list of recorded content is held centrally means that a recommendation engine technique can be used to analyze the consumption of media of the customer, both whilst mobile and also whilst viewing from the home, and then to push proposed new content to the customer based on the categorization of the content and also what other customers chose to consume who have a similar viewing preference as described in the extension section (section 3).
The fact that the content that the customer consumes whilst mobile is known allows greater targeting of additional content that is of particular interest to mobile customers. This type of content can then be made available through an extended video on demand capability as described in the extensions section of this documents.
The fact that a customer has taken the trouble to record a particular piece of content is inherently indicative that they wish to consume that piece of content at some point. This means that the problem of finding attractive content for the mobile device service is inherently solved, because it is customer chosen content.
The discovery of the content will be a simpler and richer experience on the home system which is likely to be a large screen device. The mobile service which will have an inherently more awkward discovery mechanism can then benefit from the ease of use of a larger screen system for the purposes of discovery.

In the following the Initial PVR content update is explained. This invention proposes that via a communication channel a network based central server is informed by the PVR of the status of the recorded content, this would include but is not limited to:
The program title and date of recording
Whether the program is part of a series that the customer has indicated they want recording
Any rating that the customer has assigned to the program in terms of a favorites marking, or any other form of assessment

This information is stored in a central server, against the identity of the subscriber such that there is a relatively up to date set of per customer data that indicates the PVR contents.

Since the data that is passed from the PVR to the central served is very modest (e.g. a list of 20 recorded program titles along with durations and other associated data is estimated to be less that decabytes of actual data if suitably encoded) the communications channel between the PVR and the central server can be very low bandwidth eg:
telephone modem
dial up internet
broadband internet
wireless system (WiFi to suitable hub, Bluetooth to suitable transceiver, GPRS, UMTS, LTE1 Wimax)

Of these the telephone may be the preferred choice.

For the purposes of this paper the network based central server may particularly be a server that is assumed to be operated by a service provider, offering this service to numerous customers. As an example this would have constituent parts of, but not limited to:
A storage and communication mechanism to allow incoming data from the PVRs to be received and stored in a suitable database as described.
A media store loaded with and capable of sourcing the necessary number of streams to mobile devices that are requested as described hereinafter.
Access to the full repertoire of content that may have been recorded on the PVR via a networks based video on demand system

The trigger for the communication between the PVR and the central server could be but is not limited to the following:
A recording/deleting event at the PVR
A periodic update
A response to a request for information received from the central network server via a suitable channel (e.g. a downlink satellite broadcast channel)

Consideration must be given to the timeliness of these updates, for instance a single update once per day will mean that the information held centrally in the network is out of date by approximately 12 hours on average. Alternatively if the update is made every time some element of change occurs to the recorded content (e.g. addition or deletion of a recording,) then the bandwidth and potentially the cost of the communication between the PVR and the network need to be taken into account.

Consideration must also be given to the authentication and identification of the PVR so that the probability of an intruder deliberately or erroneously accessing the data store of another valid PVR is close to zero.

Further it is explained how the content retrieval from mobile device works.

When a customer uses a mobile device (For the purposes of this document the definition of a mobile device is: a device which is not the PVR onto which the content was initially recorded) and wishes to view the recorded content for instance the following process occurs:
i) The mobile device accesses the central server via a suitable broadband internet access pipe. This pipe needs to have sufficient bandwidth to support the encoding of the content that it will stream later in this process. Typically this will be in the range 100 k bits per second which would be suitable for a small screen mobile device, up to several Mbits per second which may be needed for a high definition device.
ii) The PVR and mobile terminal must be paired though the subscription in the network server. This means that part of the initial provisioning process must allow for the network server to discover the identity of the mobile terminal, the identity of the PVR, and to pair them, this discovery must be secure and reliable. One or more PVRs could be paired to one or more mobile terminals allowing the sharing of content between a family or other grouping.
iii) The access to the central server includes sufficient information for the mobile customer to be identified. This could be an automated process using for instance some form of header enrichment, or a manual process such as username and password. The security of this process needs to be such that the probability of an intruder deliberately or erroneously accessing the data store appearing to be this PVR and mobile owner is close to zero.
iv) This identification is used by the central server to access the data stored for the specific customers, this will be the list of content that the customer has stored on their PVR and that the PVR has previously notified to the central server as described above.
v) Having accessed the list of stored content, a page of some form is rendered at the mobile terminal to represent an electronic program guide of the stored content. This may be for instance a web page in the case that the mobile device is accessing via a browser, or a proprietary coding or some other standard coding if the mobile device is accessing by a non browser application, for instance a client designed specifically for this purpose.
vi) The customer uses the electronic program guide to choose a previously recorded piece of content. This selection is then indicated back to the server by for instance clicking a cursor onto the item involved.
vii) The server accesses a central video on demand store of all recent programs and begins to play a stream of the selected program from the video on demand (VOD) store to the specific mobile device which has chosen it. The VOD store is a common store servicing all/many customers. In general the underlying protocol between the mobile device and the network server will be a point to point protocol, not a broadcast protocol, because the content timing and choice will be unique to each individual user, rendering broadcast techniques uneconomic.
viii) The combination of the user specific stored lists of content and the VOD store of recent programs together form a virtual instance of the actual PVR that resides at the customers chosen premises.
ix) When accessing the electronic program guide the mobile terminal could have the ability to add new recordings to those already on the PVR, this being signaled to the PVR from the network server via a suitable communications channel, and also to delete recordings on the PVR again this being signaled to the PVR via a suitable channel.

In addition to the basic invention that is described in the previous sections there are also some other extensions that the technology allows the operator to take advantage:

In the case where the home PVR uses broadcast feeds predominantly for its reception of content then the opportunity for video on demand (VOD) services is very limited, because the broadcast transmission techniques would not be viable for the delivery of VOD content, there being too many simultaneous streams needed.

However, the mobile terminal uses a point to point streaming technique and whilst the primary point of this invention is to enable the customer to watch the recorded content already selected for the home PVR there is the inherent capability to deliver any content included in the entire content catalogue accessible by the network server to the mobile device via the same streaming mechanism, and at the instant that the customer is watching the mobile terminal.

This then opens the opportunity to allow the operator of the service to use a recommendation engine to push other viewing suggestion which can be any content from the entire catalogue, based on for instance but not limited to:
The customers known viewing history
The customer's known mobile viewing history
The current total content of their PVR
The currently selection that the customer has made on the mobile terminal
Recommendations from other customers with similar viewing patterns.

The service outlined in section above can be further enhanced to provide an opportunity for up selling the customer onto a full video on demand service. The service outlined before allows a commitment free method for the customer to

experience the benefits of video on demand without the need to engage in any home CPE equipment configuration, software download, additional subscription, or other complexity until the point where they are certain that they wish to upgrade to VOD.

Whilst the live feed of adverts via the broadcast channel can be targeted easily to be specific to that channel, a video on demand or similar point to point system allows a far more targeted channel to the customer. The nature of the advert being shown can for instance be chosen on the basis of but not limited to:
the program being watched
the historical viewing pattern of the customer of mobile terminal
the required segment defined by the advertiser and its match with this customer

In addition the fact that the mobile terminal is likely to be a personal device whereas the home PVR and associated display equipment is more likely to be a family/community device means that any advertising can be made much more individual on the mobile terminal device and inserted into the transmitted streams than the segmentation and transmission technology would allow on the broadcast channels to the PVR device.

The overall process as described above is shown in diagrams 1 to 3. The invention is explained in greater detail in the following by means of exemplary embodiments with reference to the associated drawing, in which:

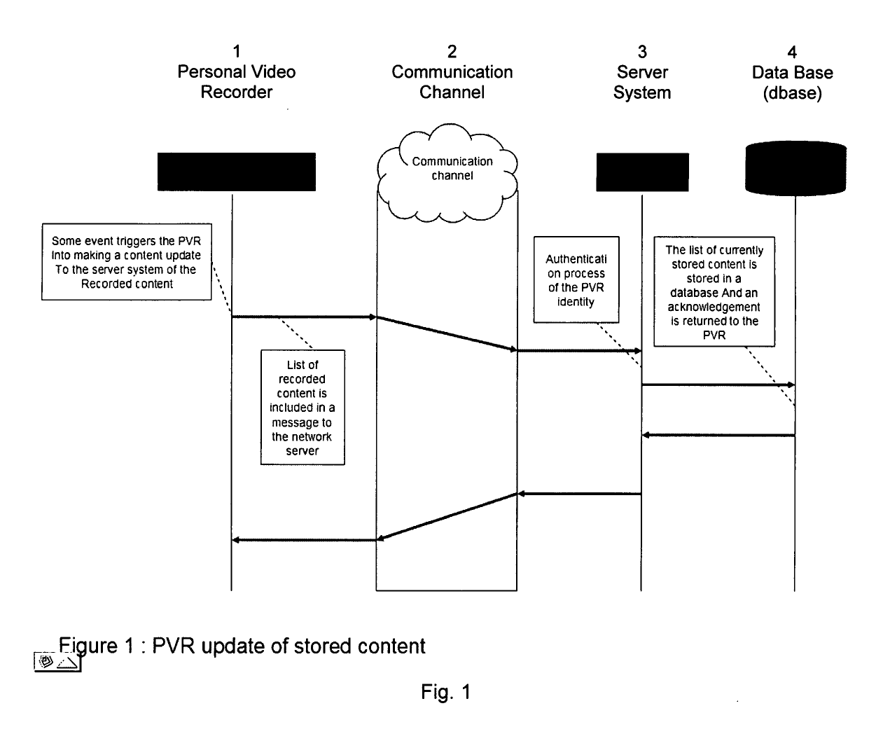

FIG. 1 shows a schematic diagram of the recording and storage method;

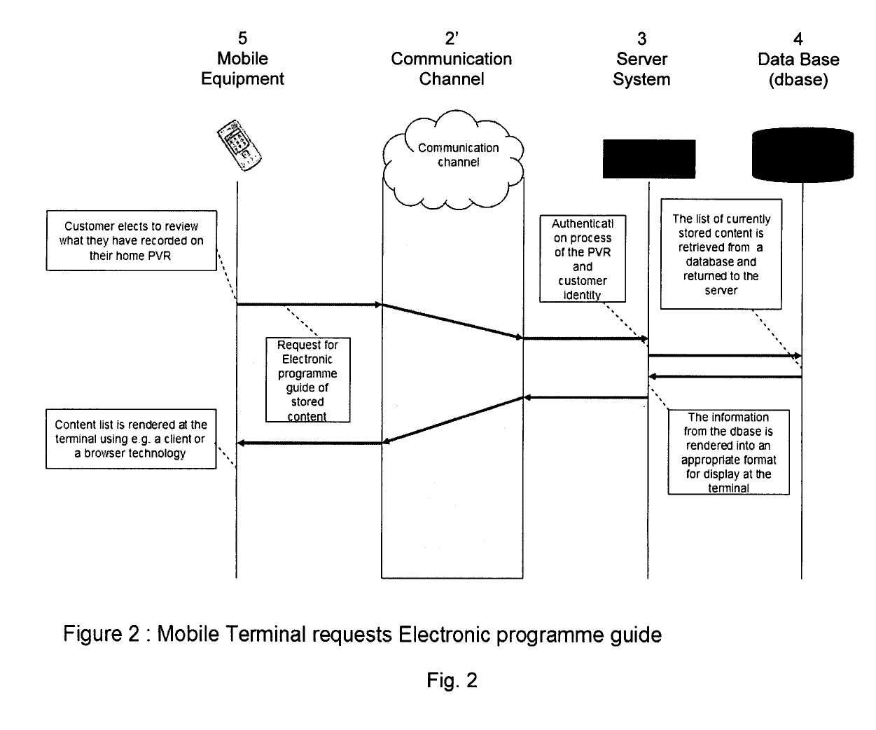

FIG. 2 shows a schematic diagram of a request for and transfer of an electronic program guide using a mobile equipment;

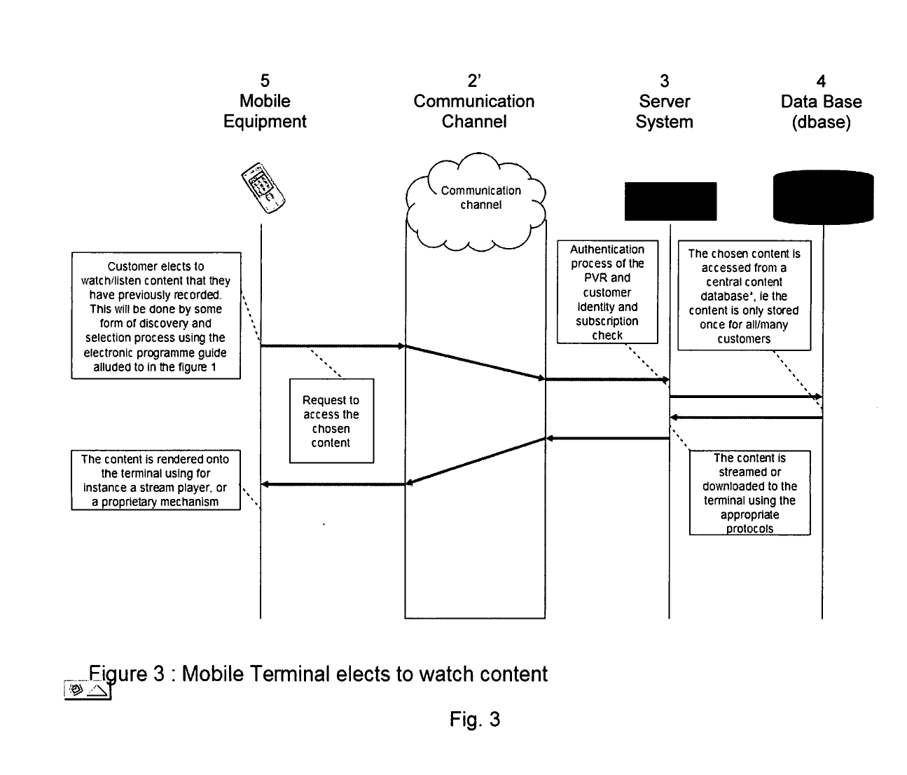

FIG. 3 shows a schematic diagram of a request for and transfer of a datastream containing a recorded program from the database using a mobile equipment.

FIG. 1 shows the Initial PVR content update. Some event, e.g. a recording/deleting event at the Personal Video Recorder (PVR), triggers the Personal Video Recorder 1 into making a content update to the server system 3 of the recorded content stored in the database 4.

Via a communication channel 2 a network based central server 3 is informed by the PVR 1 of the status of the recorded content, including the program title and date of recording. This information is stored in a central server 3 which is a web server, against the identity of the subscriber such that there is a relatively up to date set of per customer data that indicates the PVR contents. The communication channel 2 is build up by an internet access.

The trigger for the communication between the PVR 1 and the central server 3 via the communication channel 2 is in this case a recording/deleting event at the PVR 1. Alternatively the trigger can be a periodic update or a response to a request for information received from the central network server via a suitable channel.

Consideration must be given to the authentication and identification of the PVR 1 so that the probability of an intruder deliberately or erroneously accessing the data store 4 of another valid PVR is close to zero.

The list of currently stored content recorded by the video recorder 1 is transferred via the server 3 to the database 4 and stored in the database 4. Further an acknowledgment is returned from the database 4 via the server 3 and further using the communication channel 2 to the PVR 1.

When a customer uses a mobile equipment or mobile device 5 (For the purposes of this document the definition of a mobile device is: a device which is not the PVR onto which the content was initially recorded) and wishes to view the recorded content the following process occurs as shown in FIGS. 2 and 3:

The mobile device 5 accesses the central server 3 via a suitable broadband internet access pipe 2′, named communication channel in FIGS. 2 and 3. This channel 2′ needs to have sufficient bandwidth to support the encoding of the content that it will stream later in this process. Typically this will be in the range 100 k bits per second which would be suitable for a small screen mobile device 5, up to several Mbits per second which may be needed for a high definition device.

The PVR 1 and mobile terminal 5 must be paired though the subscription in the network server 3. This means that part of the initial provisioning process must allow for the network server 3 to discover the identity of the mobile terminal 5, the identity of the PVR 1, and to pair them, this discovery must be secure and reliable. One or more PVRs 1 could be paired to one or more mobile terminals 5 allowing the sharing of content between a family or other grouping.

The access to the central server 3 includes sufficient information for the mobile customer to be identified. This could be an automated process using for instance some form of header enrichment, or a manual process such as username and password or the MSISDN of the mobile equipment 5. The security of this process needs to be such that the probability of an intruder deliberately or erroneously accessing the data store 4 appearing to be this PVR 1 and mobile owner is close to zero.

This identification is used by the central server 3 to access the data stored in the database 4 for the specific customers, this will be the list of content that the customer has stored on their PVR 1 an that the PVR 1 (not shown in FIGS. 2 and 3) has previously notified to the central server as described above (see FIG. 1).

Having accessed the list of stored content from the database 4, a page of some form is rendered at the mobile terminal 5 to represent an electronic program guide of the stored content. This may be for instance a web page in the case that the mobile device 5 is accessing via a browser, or a proprietary coding or some other standard coding if the mobile device is accessing by a non browser application, for instance a client designed specifically for this purpose. The customer uses the electronic program guide to choose a previously recorded piece of content. This selection is then indicated back to the server by for instance clicking a cursor onto the item involved.

The server 3 accesses a central video on demand store 4 of all recent programs and begins to play a stream of the selected program from the VOD store 4 to the specific mobile device 5 which has chosen it. The VOD store 4 is a common store servicing all/many customers. In general the underlying protocol between the mobile device 5 and the network server 3 will be a point to point protocol, not a broadcast terminal, because the content timing and choice will be unique to each individual user, rendering broadcast techniques uneconomic.

The combination of the user specific stored lists of content and the VOD store (database 4) of recent programs together form a virtual instance of the actual PVR 1 that resides at the customers chosen premises. When accessing the electronic program guide the mobile terminal 5 could have the ability to add new recordings to those already on the PVR 1, this being signaled to the PVR 1 from the network server 3 via a suitable communications channel 2, and also to delete recordings on the PVR 1 again this being signaled to the PVR 1 via a suitable channel 2.

The communication channels 2, 2′ between the PVR 1 and the server 3 (channel 2) as well as between the mobile equipment 5 and the server 3 (channel 2′) may be of the same type, e.g. using a public land mobile network, or may be of different types as described in the example given above.

1-18. (canceled)

19. A method of storage or access to records of television programs that are recorded by a personal video recorder that is at least temporarily connectable to a server using a first communication channel, wherein via said first communication channel a dataset of recording information about a recorded program with the identity of the recorded program is transferred to the server and stored in a database by the server using a storage mechanism, and that a list of stored datasets is available from the database by a piece of mobile equipment via a second communication channel, the list being displayed by the mobile equipment as a page to represent an electronic program guide of the stored content, a piece of content being selectable from the electronic program guide, this selection being then indicated back to the server, and that the server accesses a central video-on-demand store and begins to play a stream of the selected program from the video-on-demand store to the specific mobile equipment that has selected it.

20. The method defined in claim 19, wherein the server is a network-based web server.

21. The method defined in claim 19, wherein the transferred and stored dataset includes the program title or the date of recording or the length of recording or whether the program is a part of a series or program classification.

22. The method defined in claim 19, wherein the first communication channel is using a telephone modem or dial up internet access or broadband internet access or wireless ethernet or bluetooth to a transceiver or a mobile telephone connection via a public land mobile network.

23. The method defined in claim 19, wherein the video recorder is at least connected to the server on every recording or deleting event at the personal video recorder after a settable period or periodically.

24. The method defined in claim 19, wherein the database is updated by storing or deleting datasets on every recording or deleting event at the personal video recorder, periodically, or after a settable period.

25. The method defined in claim 1, wherein the personal video recorder is identified by an identification or authentication.

26. The method defined in claim 19, wherein the second communication channel used by the mobile equipment is a public land mobile network.

27. The method defined in claim 19, wherein the mobile equipment is identified by an identification or authentication.

28. The method defined in claim 19, wherein at least one video recorder and at least one piece of more mobile equipment that are accessible to the server or the database are paired by the server by identification or authentication of the personal video recorders and the mobile equipment.

29. The method defined in claim 19, wherein the mobile equipment is identified by using the Mobile Subscriber Integrated Services Digital Network Number.

30. The method defined in claim 19, wherein the personal video recorder or mobile equipment is identified by capturing username and password.

31. The method defined in claim 19, wherein a selectable dataset is transferable as a datastream from the database via the server and the communication channel to the mobile equipment.

32. The method defined in claim 19, wherein programs to be recorded by the personal video recorder can be selected from an electronic program guide using the mobile equipment by transmitting a recording instruction from the mobile equipment via the server to the personal video recorder.

33. The method defined in claim 19, wherein a list of similar or supplemental programs is provided by the server.
